(19) United States
(12) Patent Application Publication
(10) Pub. No.: US 2017/0003872 A1
(43) Pub. Date: Jan. 5, 2017

(54) TOUCH-ENCODED KEYBOARD

(71) Applicant: International Business Machines Corporation, Armonk, NY (US)

(72) Inventor: Samir K. Dash, Bangalore (IN)

(21) Appl. No.: 14/790,333

(22) Filed: Jul. 2, 2015

(51) Int. Cl. G06F 3/0488; G06F 3/041

(52) U.S. Cl. CPC G06F 3/04886; G06F 3/041

(57) ABSTRACT

In an approach to user input using a touch-encoded keyboard, according to an embodiment of the present invention, interaction of one or more touch objects with a touch-sensitive surface of a device is detected, the number of touch objects is determined, and one or more characteristics associated with the interaction are captured. A transformation of the touch input to data input or command input is performed based on a predefined mapping. Embodiments of the invention can be used to enable data input to devices with touch-sensitive surfaces measuring only square millimeters in size.

### BACKGROUND OF THE INVENTION

The present invention relates generally to data input interfaces for electronic devices, and more particularly to systems and methods for inputting data to touch-sensitive devices.

As the evolution of computing technology permits the design of ever-smaller digital devices, data input interfaces such as keyboards must also evolve over time to meet the challenge posed by increasingly constrained surface space on wearables and other small electronics. Alternatives to the traditional computer keyboard model can facilitate data input where surface area is limited.

### SUMMARY

According to one embodiment of the present invention, a method for generating user input is provided. The method can include detecting interaction of one or more touch objects with a touch-sensitive surface. The number of touch objects is determined. One or more characteristics of the interaction are determined. The interaction is mapped to user input based on an input mapping. The input is outputted for further processing.

According to another embodiment of the present invention, a computer program product is provided. The computer program product includes one or more computer readable storage media and program instructions stored on the one or more computer readable storage media. The program instructions include instructions to detect interaction of one or more touch objects with a touch-sensitive surface; program instructions to determine a number of the one or more touch objects; program instructions to detect one or more characteristics associated with the interaction; program instructions to transform the interaction into user input based on an input mapping; and program instructions to output the user input for further processing.

According to another embodiment of the present invention, a user input system is provided. The user input system includes one or more touch-sensitive surfaces, one or more computer processors, one or more user interfaces, one or more computer readable storage media, and program instructions stored on the one or more computer readable storage media for execution by at least one of the one or more computer processors. The program instructions include instructions to detect interaction of one or more touch objects with a touch-sensitive surface; program instructions to determine a number of the one or more touch objects; program instructions to detect one or more characteristics associated with the interaction; program instructions to transform the interaction into user input based on an input mapping; and program instructions to output the user input for further processing.

### BRIEF DESCRIPTION OF THE DRAWINGS

FIG. 1 is a block diagram of a computing environment, in accordance with an embodiment of the present invention;

FIG. 2 is a flowchart illustrating operational steps for processing touch input, in accordance with an embodiment of the present invention;

FIG. 3A shows an example of a touchscreen user interface, and FIG. 3B shows an exemplary element of a touchscreen user interface, in accordance with an embodiment of the present invention;

FIG. 4 shows an example of a user interface with a touch-sensitive panel and a non-touch-sensitive display, in accordance with an embodiment of the present invention; and

FIG. 5 is a block diagram of internal and external components of the computing environment of FIG. 1, in accordance with an embodiment of the present invention.

### DETAILED DESCRIPTION

Embodiments described herein avoid the shortfalls of existing data input systems for small electronic devices such as wearables by providing methods and systems for translating combinations of sliding and tapping actions to user input, i.e., data input or commands, based on a predefined mapping. The touch-encoded approach to data input reduces the scope of error as compared with voice input approaches (e.g., due to noisy environments) or primarily point-and-tap approaches (e.g., due to shaky fingers in moving environments), and is more convenient to use than approaches always requiring an Internet connection (e.g., cloud-based voice input systems) or treating the size-constrained device as auxiliary to a larger device used for data input, such as a mobile phone. For these reasons, a touch-encoded input system relying on simple gestures can be implemented in devices with touch-sensitive surfaces measuring only square millimeters in size.

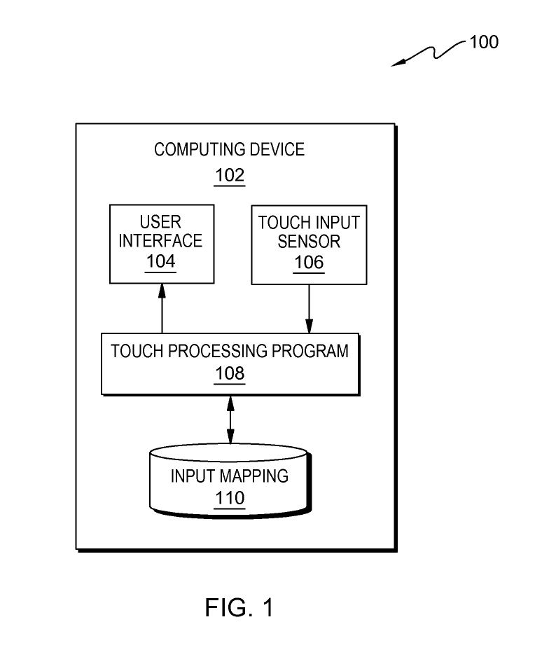

The embodiments described herein, with reference to the Figures, provide computer-implemented methods and systems for inputting data to touch-sensitive devices, and are scalable and customizable for implementation in different types of touch-sensitive devices of varying sizes. FIG. 1 shows a block diagram of a computing environment 100, in accordance with one embodiment of the present invention. FIG. 1 is provided for the purposes of illustration and does not imply any limitations with regard to the environments in which different embodiments can be implemented. Many modifications to the depicted environment can be made by those skilled in the art without departing from the scope of the invention as recited in the claims.

Computing environment 100 includes computing device 102, which can be, in some embodiments, connected to other computing devices (not shown) over a network (not shown). The network (not shown) can be, for example, a telecommunication network, a local area network (LAN), a wide area network (WAN), such as the Internet, or a combination of the three, and can include wired, wireless, or fiber optic connections. The network (not shown) can include one or more wired and/or wireless networks that are capable of receiving and transmitting data, voice, and/or video signals, including multimedia signals that include voice, data, and video information. In general, the network (not shown) can be any combination of connections and protocols that will support communications between computing device 102 and other computing devices (not shown).

Computing device 102 can be a tablet computer, a smartphone, a smart watch, smart eyewear, a virtual reality headset, a home thermostat, or any programmable electronic device capable of executing machine readable program instructions. Computing device 102 includes user interface 104, touch input sensor 106, touch processing program 108, and input mapping 110.

User interface 104 provides an interface between a user of computing device 102 and the computing device. User interface 104 can be, but is not limited to being, a graphical user interface (GUI) and can display information such as, but not limited to, text, documents, web browser windows, user options, application interfaces, and instructions for operation, and include information (such as, but not limited to, graphic, text, and sound) that a program presents to a user and the control sequences the user employs to control the program. User interface 104 can also be mobile application (“app”) software that provides an interface between a user of computing device 102 and other computing devices such as but not limited to a server system (not shown) connected over a network (not shown).

Touch input sensor 106 can be, but is not limited to being, layers of capacitive material arranged in a coordinate system (or “grid”). This example is provided for the purposes of illustration only. Because embodiments of the present invention can be implemented in various devices, including but not limited to iPhones, Android smartphones, Fitbit wristbands, and other touch-sensitive electronic devices, the identity of touch input sensor 106 can vary depending on the implementation. When touch input sensor 106 detects the presence of one or more touch objects, such as but not limited to fingers, it sends electrical signals to touch processing program 108 for analysis.

Touch processing program 108 analyzes the electrical signals in order to identify predefined touch characteristics, specifically the number of touch objects (e.g., one or multiple fingers) and one or more additional predefined characteristics, such as but not limited to the “tap” or “swipe” nature of the touch (with “swipe” also referred to herein and having the same definition as “slide”); in the case of a swipe, the direction (e.g., up, down, left, right) of the motion; and in the case of a tap, the single or multiple nature of the touch. In view of the above description, examples of interactions can include, but are not limited to, a single tap, i.e., a tap with one finger; a double tap, i.e., two taps with one finger; a single tap or double tap with more than one finger; a one-finger slide, i.e., a slide (swipe) with one finger; and a multi-finger slide, i.e., a slide (swipe) with more than one finger substantially simultaneously in substantially the same direction.

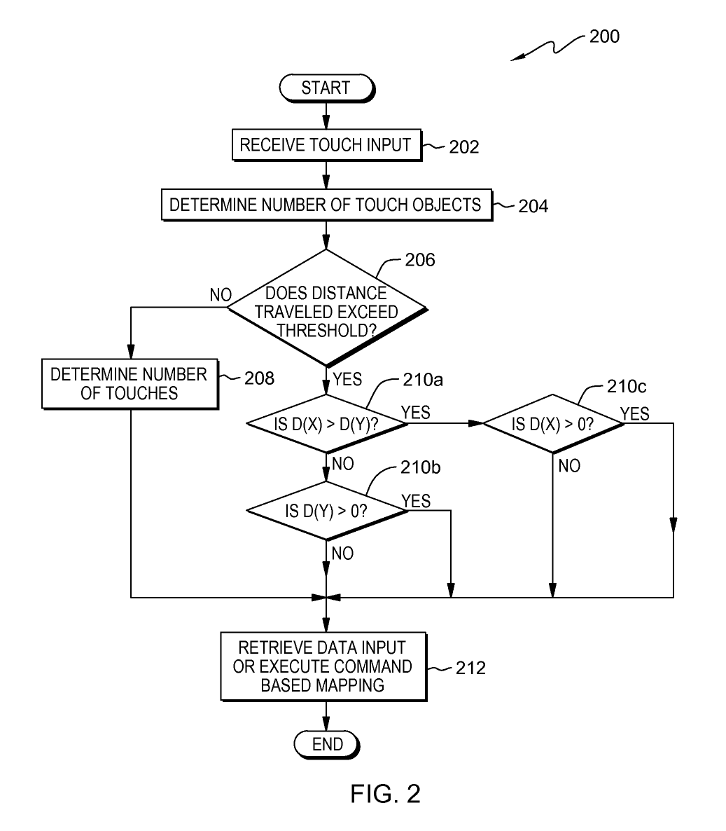

According to this embodiment, the nature of the touch, the number of touch objects, the single or multiple nature of the touch, and the direction of a swipe can be, but need not be, determined by following the operational steps described herein with reference to the flowchart 200 in FIG. 2. The steps in FIG. 2 are described for the purposes of illustration only, and it should be noted that other embodiments can employ different processes for recognizing the characteristics of touch input. For example, embodiments of the present invention can be implemented in iPhones, Android based devices, and other touch-sensitive electronic devices that follow other procedures for recognizing touch characteristics that will be transformed into user input.

According to the exemplary embodiment represented by the flowchart 200 in FIG. 2, in step 202, touch processing program 108 receives touch input from the touch input sensor 106. In step 204, touch processing program 108 determines the number of touch objects in contact with touch input sensor 106. Touch processing program 108 can, for example, count the gaps between fingers making contact with touch input sensor 106 if the touch input sensor is a touchscreen (in one possible embodiment), or by counting the intervals between fingers passing over a small (e.g., 4 mm×4 mm) touch-sensitive panel (in another embodiment).

In step 206, touch processing program 108 determines whether the touch is a tap or a slide. For example, touch processing program 108 can calculate the distance traveled by the one or more touch objects over a predefined time interval and compare the distance traveled to a predefined threshold distance. Touch processing program 108 assigns (x,y) coordinates on a grid to the starting point and ending point of the touch over a predefined time interval and calculates the absolute value of the distance traveled in the x-direction (dₓ) and in the y-direction (d_{y}) over the predefined time interval. An example calculation, given starting and ending coordinates [(x1, y1), (x2, y2)], can be:

dₓ=abs[(x2)−(x1)]

d_{y}=abs[(y2)−(y1)]

Touch processing program 108 compares each of the distances (dₓ) and (d_{y}) to a predefined threshold distance (dₜ) and determines that the touch is a tap if (dₓ) and (d_{y}) are each less than (dₜ). If either (dₓ) or (d_{y}) is greater than or equal to (dₜ), touch processing program 108 determines that the touch is a slide.

If the touch is a tap, in step 208 touch processing program 108 determines the number of taps. For example, touch processing program 108 can count the number of individual times that a touch object or touch objects made contact with touch input sensor 106 over a predefined time interval.

If the touch is a slide, in step 210a-c touch processing program 108 determines the direction of the slide. For example, in step 210a, using the coordinates assigned in step 206, touch processing program 108 calculates the distances traveled in the x-direction (dₓ) and in the y-direction (d_{y}). An example calculation for determining (dₓ) and (d_{y}) can be:

dₓ=(x2)−(x1)

d_{y}=(y2)−(y1)

Touch processing program 108 compares (dₓ) and (d_{y}) in order to determine if the slide was vertical (up or down) or horizontal (left or right). In step 210b-c, touch processing program 108 uses the sign of (dₓ) or (d_{y}) to narrow the set of possible directions down to one. For example, if:
(dₓ) was greater, and negative, the touch processing program recognizes a swipe left;
(dₓ) was greater, and positive, the touch processing program recognizes a swipe right;
(d_{y}) was greater, and negative, the touch processing program recognizes a swipe down; or if
(d_{y}) was greater, and positive, the touch processing program recognizes a swipe up.

At the end of each path, in step 212, touch processing program 108 matches the input characteristics to data input or commands based on a predefined input mapping 110. Data input can include, but is not limited to, one or more letters, characters, numbers, symbols, images, or combinations of these. Commands are instructions to perform functions including, but not limited to, altering the input options available to the user or altering data input previously entered by the user. For example, commands can include, but are not limited to, an instruction to toggle between lower case and upper case letters or an instruction to delete previous input. Touch processing program 108 can, but need not in every embodiment, send the retrieved input toward the user via user interface 104.

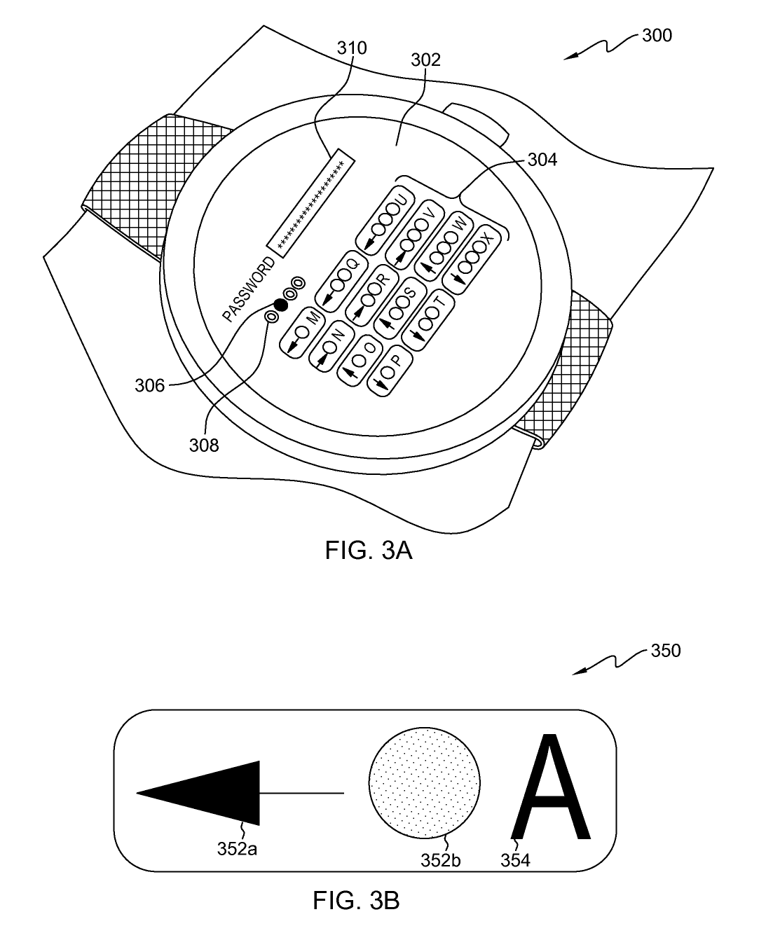

FIG. 3A shows an exemplary embodiment of the present invention implemented in a wearable device 300. In this example, user interface 104 is a touchscreen display 302. Touchscreen display 302 includes a view of data inputs available to the user and the touch characteristics to which they are mapped 304, an indicator 306 showing the view that the user is in and other indicators 308 showing other views that are available, and an input box 310 showing the data inputs that the user has already entered. FIG. 3B shows an example of a virtual key 350 that user interface 104 can display to the user. In this example, virtual key 350 shows a set of input characteristics 352a-b that are mapped to a data input 354 in the input mapping 110. In this example, one touch object 352b swiping in the direction indicated by the arrow 352a generates a data input 354 of ‘A’.

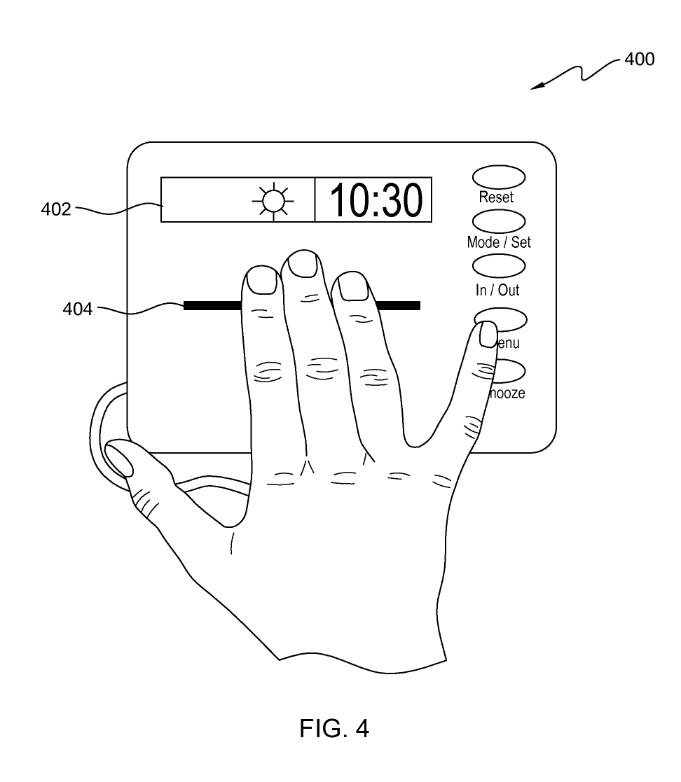

FIG. 4 shows another exemplary embodiment of the present invention implemented in a home thermostat device 400. In this example, user interface 104 comprises a non-touch-sensitive display 402 and a separate, communicatively connected touch-sensitive panel 404. According to this embodiment, touch-sensitive panel 404 acts as the input sensor 106, and display 402 communicates information such as but not limited to data input retrieved from input mapping 110 to the user.

FIG. 3A-B and FIG. 4 are provided for the purposes of illustration and do not imply any limitations with regard to possible embodiments and their implementation.

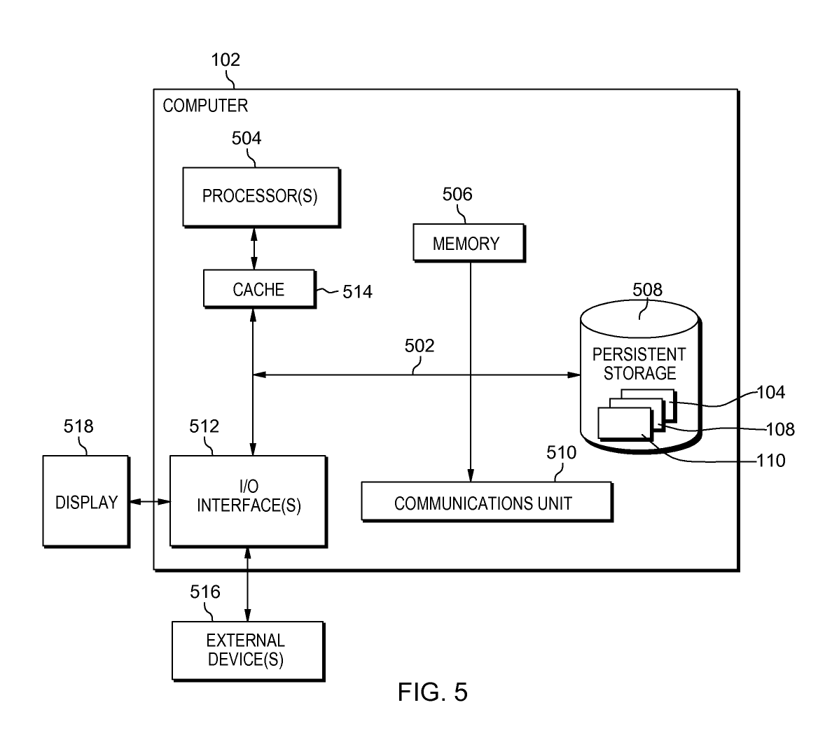

FIG. 5 is a block diagram of components of a computing device executing operations for touch-encoded data input, in accordance with an embodiment of the present invention. For example, FIG. 5 is a block diagram of computing device 102 within computing environment 100 executing operations of touch analysis program 108.

It should be appreciated that FIG. 5 provides only an illustration of one implementation and does not imply any limitations with regard to the environments in which different embodiments may be implemented.

Computing device 102 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) and cache memory 514. In general, memory 506 can include any suitable volatile or non-volatile computer-readable storage media. Cache 514 is a fast memory that enhances the performance of processor(s) 504 by holding recently accessed data, and data near recently accessed data, from memory 506.

Program instructions and data used to practice embodiments of the present invention, e.g., user interface 104, touch processing program 108, and input mapping 110 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used in persistent storage 508 may also be removable. For example, a removable hard disk drive may be used for persistent storage. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Touch analysis program 108 can be downloaded to persistent storage 508 through communications unit 510.

I/O interface(s) 512 allows for input and output of data with other devices that may be connected to computing device 102. For example, I/O interface 512 can provide a connection to external devices 516. External devices 516 can include portable computer-readable storage media such as, for example, thumb drives, portable optical or magnetic disks, and memory cards. Software and data used to practice embodiments of the present invention (e.g., touch analysis program 108) can be stored on such portable computer-readable storage media and can be loaded onto persistent storage 508 via I/O interface(s) 512. I/O interface(s) 512 can also connect to a display 518.

Display 518 can provide a mechanism to display data to a user and may be, for example, a computer monitor or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for generating user input, the method comprising the steps of:
detecting, by one or more processors, interaction of one or more touch objects with a touch-sensitive surface;
determining, by one or more processors, a number of the one or more touch objects;
detecting, by one or more processors, one or more characteristics associated with the interaction;
responsive to determining the number of touch objects and detecting one or more characteristics associated with the interaction, transforming, by one or more processors, the interaction into user input based on an input mapping; and
outputting the user input for further processing.

2. The method of claim 1, wherein the one or more touch objects are fingers.

3. The method of claim 1, wherein the one or more characteristics associated with the interaction are at least one of a slide, a tap, a direction of the slide, and the number of taps over a predefined time interval.

4. The method of claim 1, wherein the user input is at least one of data input and command input.

5. The method of claim 4, wherein data input is at least one of letters, characters, numbers, symbols, and images.

6. The method of claim 4, wherein command input is an instruction to perform one or more functions comprising altering input options available to the user and altering data input previously entered by the user.

7. A computer program product comprising:
one or more computer readable storage media and program instructions stored on the one or more computer readable storage media, the program instructions comprising:
program instructions to detect interaction of one or more touch objects with a touch-sensitive surface;
program instructions to determine a number of the one or more touch objects;
program instructions to detect one or more characteristics associated with the interaction;
program instructions to transform the interaction into user input based on an input mapping; and
program instructions to output the user input for further processing.

8. The computer program product of claim 7, wherein the one or more touch objects are fingers.

9. The computer program product of claim 7, wherein the one or more characteristics associated with the interaction are at least one of a slide, a tap, a direction of the slide, and the number of taps over a predefined time interval.

10. The computer program product of claim 7, wherein the user input is at least one of data input and command input.

11. The computer program product of claim 10, wherein data input is at least one of one or more letters, characters, numbers, symbols, and images.

12. The computer program product of claim 10, wherein a command input is an instruction to perform one or more functions comprising altering input options available to the user and altering data input previously entered by the user.

13. A computer system comprising:
one or more touch-sensitive surfaces;
one or more computer processors;
one or more user interfaces;
one or more computer readable storage media; and
program instructions stored on the one or more computer readable storage media for execution by at least one of the one or more processors, the program instructions comprising:
program instructions to detect interaction of one or more touch objects with a touch-sensitive surface;
program instructions to determine a number of the one or more touch objects;
program instructions to detect one or more characteristics associated with the interaction;
program instructions to transform the interaction into user input based on an input mapping; and
program instructions to output the user input for further processing.

14. The computer system of claim 13, wherein the one or more user interfaces are displays.

15. The computer system of claim 13, wherein the one or more touch objects are fingers.

16. The computer system of claim 13, wherein the one or more characteristics associated with the interaction are at least one of a slide, a tap, a direction of the slide, and the number of taps over a predefined time interval.

17. The computer system of claim 13, wherein user input is at least one of data input and command input.

18. The computer system of claim 17, wherein data input is at least one of one or more letters, characters, numbers, symbols and images.

19. The computer system of claim 17, wherein a command input is an instruction to perform one or more functions comprising altering input options available to the user and altering data input previously entered by the user.

20. The computer system of claim 14, wherein the user input is communicated to the user on the one or more displays.
